(19) United States
(12) Patent Application Publication
(10) Pub. No.: US 2008/0028087 A1
(43) Pub. Date: Jan. 31, 2008

(54) A client/server multimedia system and method

(75) Inventors: Su-Yuan Chang, Hsinchu (TW); Yin-Ju Chen, Hsinchu (TW)

Correspondence Address: WPAT, PC, 7225 BEVERLY ST., ANNANDALE, VA, 22003, US

(73) Assignee: VICOTEL, INC., Hsinchu (TW)

(21) Appl. No.: 11/460,760

(22) Filed: Jul. 28, 2006

(51) Int. Cl. G06F 15/16

(52) U.S. Cl. 709/230; 709/203

(57) ABSTRACT

A client/server multimedia system and method are disclosed. The client/server multimedia system and method comprise a remote control and a controlled computer. The controlled computer sends a multimedia data to the remote control according to the operations of the users sent from the remote control, and then the remote control plays the multimedia data or resends the multimedia data to a DVD player, a TV, or a computer, etc. Besides, the remote control may send the audio, the video, or e-mail of the users to the controlled computer, and then the controlled computer resends the audio, the video, or the e-mail of the users to a remote computer over the network.

### BACKGROUND OF THE INVENTION

1. Field of the Invention

The present invention generally relates to a multimedia system, and more particularly to a client/server multimedia system.

2. Description of the Prior Art

Traditionally, a user must directly operate a computer 100 for performing a program 102 or retrieving a multimedia data 104 from a remote computer 106 over the VoIP protocol or the VoIM protocol as shown in FIG. 1, but it is impossible to face or carry the computer 100 anytime for the user. This situation always limits the user's sphere of activities and confuses us all the time.

Therefore, a need exists for a client/server multimedia system and method that play and resend a multimedia data. The present invention provides a client/server multimedia system and method.

### SUMMARY OF THE INVENTION

Therefore, in accordance with the previous summary, objects, features and advantages of the present disclosure will become apparent to one skilled in the art from the subsequent description and the appended claims taken in conjunction with the accompanying drawings.

The present invention avoids the inconvenient of performing any programs of the computer, wherein the present invention relates to a client/server multimedia system and method for playing or resending a multimedia data.

The client/server multimedia system and method comprise a remote control and a controlled computer. The controlled computer sends a multimedia data to the remote control via the radio according to the operations of the users sent from the remote control via the infrared ray, and then the remote control plays the multimedia data or resends the multimedia data to a DVD player, a TV, or a computer, etc. Besides, the remote control may send the audio, the video, or e-mail of the users to the controlled computer via the infrared ray, and then the controlled computer resends the audio, the video, or the e-mail of the users to a remote computer over the VoIP protocol or the VoIM protocol.

Also, the audio, the video, or e-mail of the users may be encoded, encrypted, or compressed by one of the remote control and the controlled computer, and decode, decrypted, or decompressed by the other of the remote control and the controlled computer for the safety or the rate of the transmission.

Both the foregoing and the following descriptions are exemplary and explanatory only and are not intended to limit the claimed invention in any manner whatsoever.

### BRIEF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1 is a diagram illustrates a block diagram according to the prior art;

FIG. 2a, FIG. 2b, FIG. 2c, and FIG. 2d are diagrams depict block diagrams according to the first embodiment of the present invention;

FIG. 3a, FIG. 3b, and FIG. 3c are diagrams show block diagrams according to the second embodiment of the present invention; and

FIG. 4a, FIG. 4b, FIG. 4c, and FIG. 4d are diagrams represent block diagrams according to the third embodiment of the present invention.

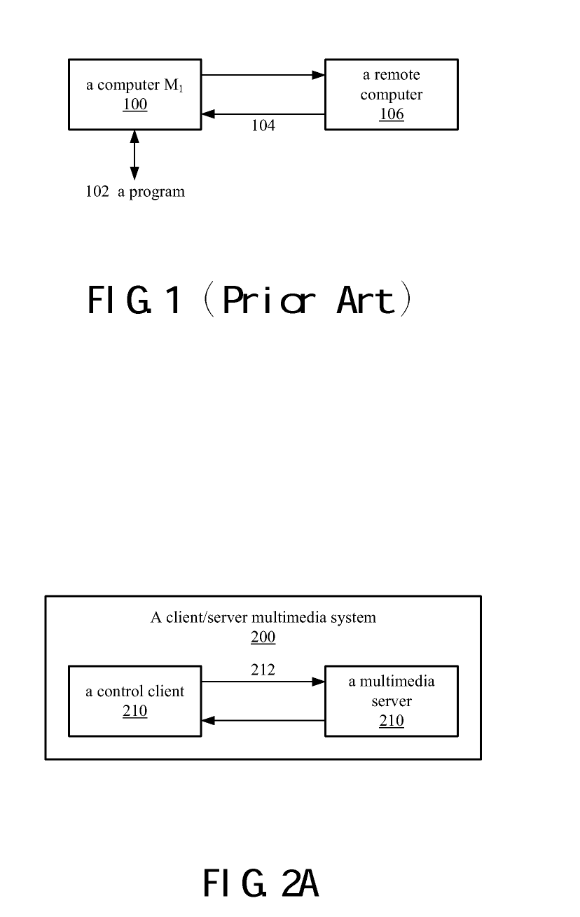

### DETAILED DESCRIPTION OF THE PREFERRED EMBODIMENTS

The present disclosure can be described by the embodiments given below. It is understood, however, that the embodiments below are not necessarily limitations to the present disclosure, but are used to a typical implementation of the invention.

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary the intent is to cover all alternatives, modifications and equivalents included within the spirit and scope of the invention as defined by the appended claims.

It is noted that the drawings presents herein have been provided to illustrate certain features and aspects of embodiments of the invention. It will be appreciated from the description provided herein that a variety of alternative embodiments and implementations may be realized, consistent with the scope and spirit of the present invention.

It is also noted that the drawings presents herein are not consistent with the same scale. Some scales of some components are not proportional to the scales of other components in order to provide comprehensive descriptions and emphasizes to this present invention.

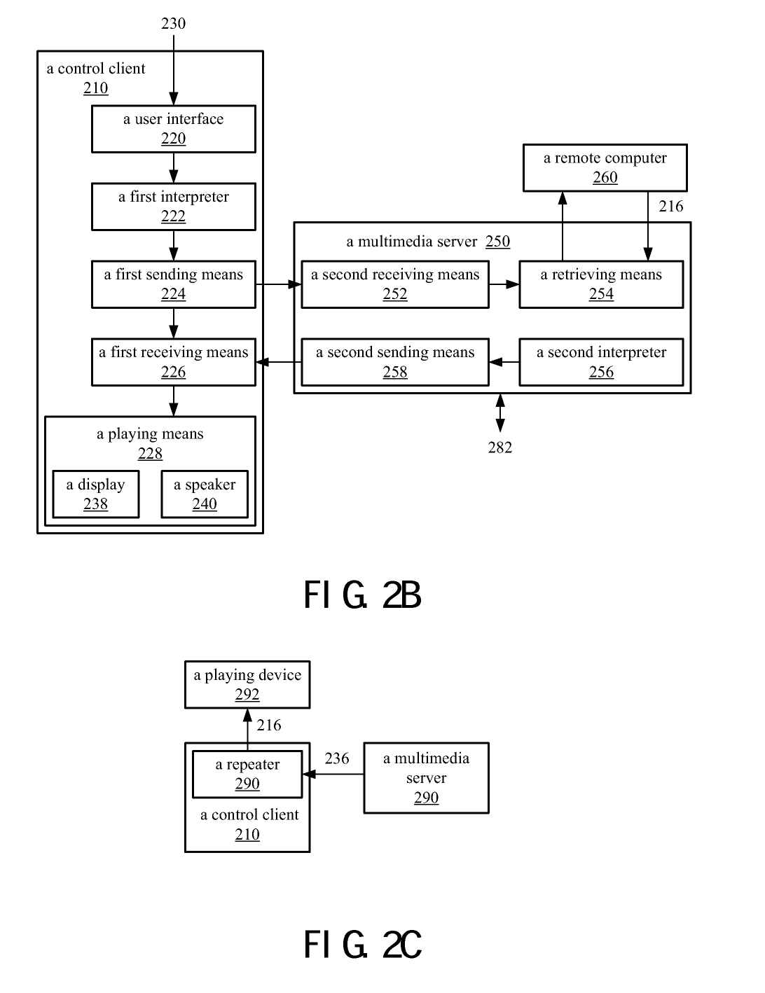

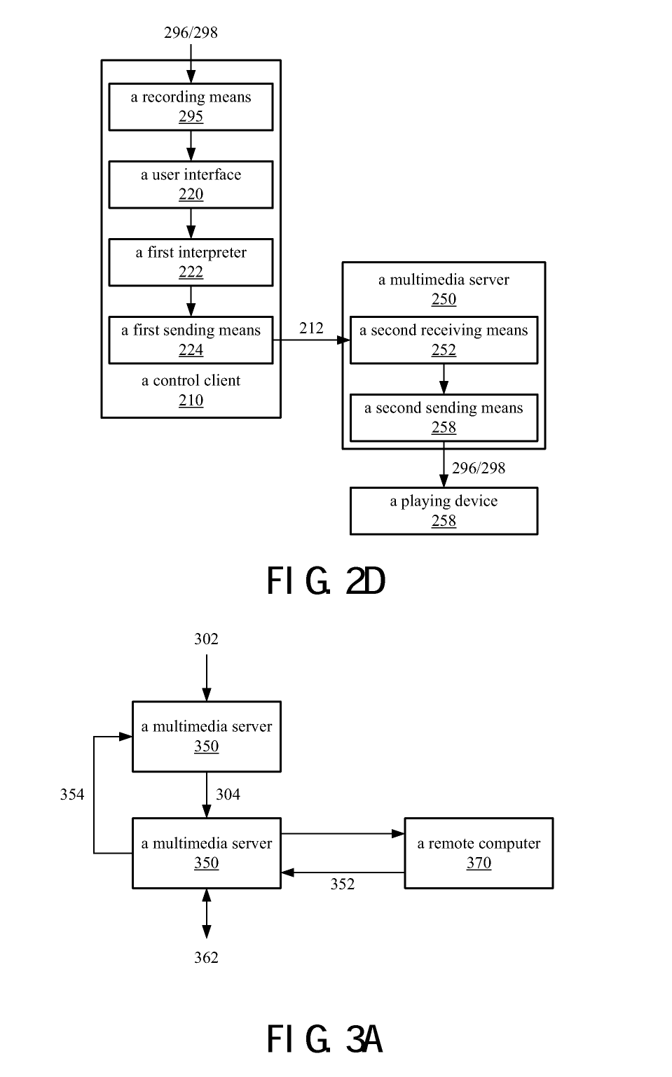

FIG. 2a illustrates a block diagram according to the first embodiment of the present invention. A client/server multimedia system 200 comprises a control client 210 and a multimedia server 250. The control client 210 sends a first signal 212 to the multimedia server 250 directly by a first wireless protocol and plays a multimedia data 216 received from the multimedia server 250 by a second wireless protocol.

As shown in FIG. 2b, the control client 210 comprises a user interface 220, a first interpreter 222, a first sending means 224, a first receiving means 226, and a playing means 228. The user interface 220 records the operations of users 230, wherein the user interface 220 may be a plurality of bottoms for generating the operations of users 230 whenever each of the bottoms is pressed, the first interpreter 222 translates the operations of users 230 into the first signal 212, the first sending means 224 sends the first signal 212 by the first wireless protocol, the first receiving means 226 receives a second signal 236 by the second wireless protocol, and the playing means 228 further comprises a display 238 and a speaker 240 for playing the multimedia data 216. Besides, the operations of users 230 further include audio, video, e-mail and so on.

The multimedia server 250 receives the first signal 212 by the first wireless protocol and sends the second signal 236 by the second wireless protocol. The multimedia server 250 comprises a second receiving means 252, a retrieving means 254, a second interpreter 256, and a second sending means 258. The second receiving means 252 receives the first signal 212 by the first wireless protocol, the retrieving means 254 retrieves the multimedia data 216 over the network according to the first signal 212, wherein the multimedia data 216 is received from a remote computer 260, the second interpreter 256 translates the multimedia data 216 into the second signal 236, and the second sending means 258 sends the second signal 236 by the second wireless protocol.

According to the first embodiment of the present invention, the first signal 212 may be analog as being sent by infrared ray and the second signal 236 may be digital as being sent by radio. Nevertheless, the first signal 212 and the second signal 236 may also be sent by the same protocol whether the protocol is analog or digital. In addition, the multimedia data 216 is retrieved over the VoIP (Voice over Internet Protocol) protocol or the VoIM (Voice over Instant Messenger) protocol, wherein the retrieving means 254 performs an instant messenger program for retrieving the multimedia data 216 over the VoIM protocol from another instant messenger program performed on the remote computer 260. Furthermore, the multimedia server 250 may perform a program 282 according to the first signal 212 over the VoIP protocol or the VoIM protocol.

As shown in FIG. 2c, the control client 210 further comprises a repeater 290. The repeater 290 sends the multimedia data 216 to a playing device 292 for playing the multimedia data 216 received from the control client 210 by a third wireless protocol.

As shown in FIG. 2d, the user interface 220 further comprises a recording means 295 for recording the audio of the users 296 or the video of the users 298, and the first sending means 224 sends the first signal 212 by the first wireless protocol, wherein the first signal 212 is translated from the audio of the users 296 or the video of the users 298 by the first interpreter 222. Then the multimedia server 250 may play the audio of the users 296 or the video of the users 298, or the second sending means 258 resends the audio of the users 296 or the video of the users 298 to the playing device 292 after the second receiving means 252 receives the first signal 212 by the first wireless protocol.

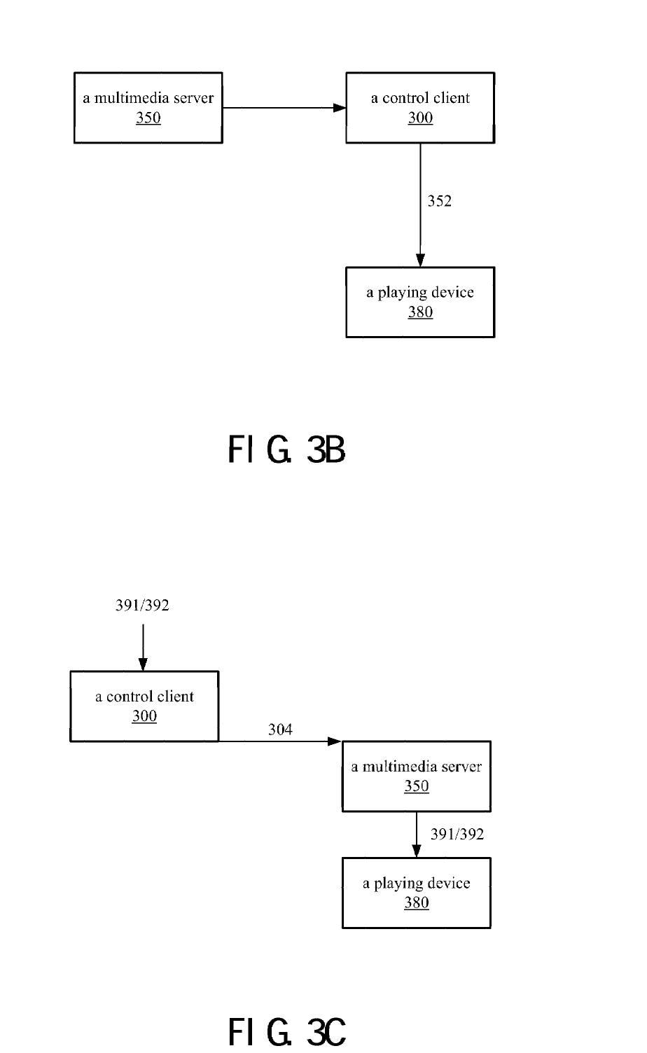

FIG. 3a illustrates a block diagram according to the second embodiment of the present invention. A control client 300 records the operations of users 302, translates the operations of users 302 into a first signal 304, and sends the first signal 304 to a multimedia server 350 directly by a first wireless protocol. A multimedia server 350 receives the first signal 304 and translates a multimedia data 352 into a second signal 354 after the multimedia server 350 retrieves the multimedia data 352 over a network according to the first signal 304, wherein the multimedia data 352 is received from a remote computer 370. The control client 300 plays the multimedia data 352 after the control client 300 receives the second signal 354 sent by the multimedia server 350 via a second wireless protocol. Besides, the operations of users 302 further include audio, video, e-mail and so on.

According to the second embodiment of the present invention, the first signal 304 may be analog as being sent by infrared ray and the second signal 354 may be digital as being sent by radio. Nevertheless, the first signal 304 and the second signal 354 may also be sent by the same protocol whether the protocol is analog or digital. In addition, the multimedia data 352 is retrieved over the VoIP protocol or the VoIM protocol, wherein the multimedia server 350 performs an instant messenger program for retrieving the multimedia data 352 over the VoIM protocol from another instant messenger program performed on the remote computer. Furthermore, the multimedia server 350 may perform a program 362 according to the first signal 304 over the VoIP protocol or the VoIM protocol.

As shown in FIG. 3b, the control client 300 further sends the multimedia data 352 to a playing device 380 for playing the multimedia data 352, wherein the multimedia data 352 is sent from the control client 300 by a third wireless protocol.

As shown in FIG. 3c, the control client 300 may record the audio of the users 391 or the video of the users 392, and send the first signal 304 by the first wireless protocol, wherein the first signal 304 is translated from the audio of the users 391 or the video of the users 392 by the control client 300. Then the multimedia server 350 plays the audio of the users 391 or the video of the users 392, or resends the audio of the users 391 or the video of the users 392 to the playing device 380 after the multimedia server 350 receives the first signal 304 by the first wireless protocol.

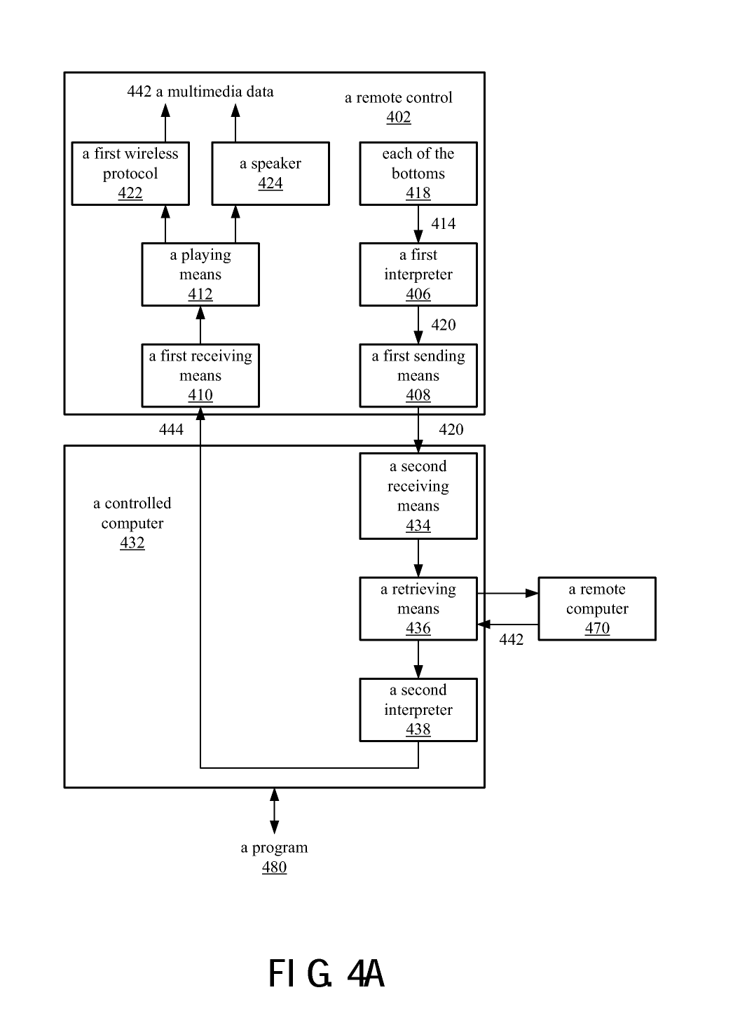

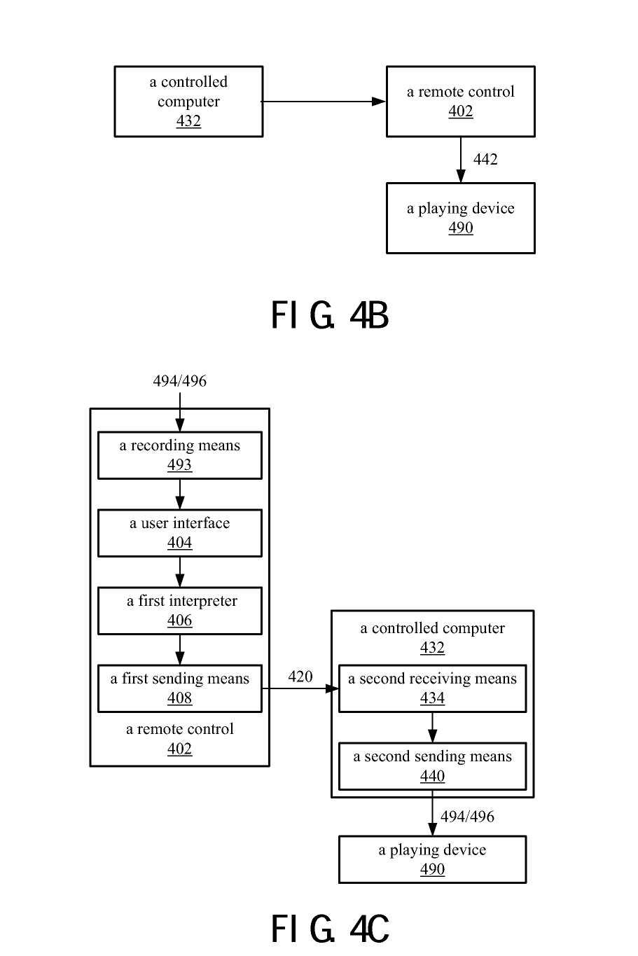

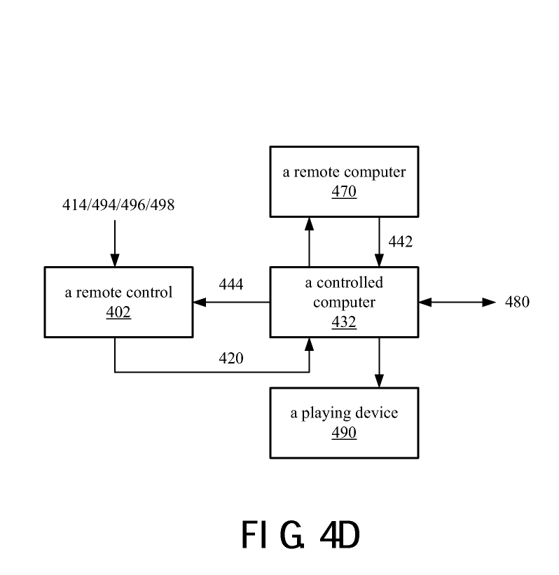

FIG. 4a illustrates a block diagram according to the third embodiment of the present invention. Actuality, a control client 400 may be a remote control 402, and a multimedia server 430 may be a controlled computer 432. The remote control 402 comprises a user interface 404, a first interpreter 406, a first sending means 408, a first receiving means 410, and a playing means 412. The controlled computer 432 comprises a second receiving means 434, a retrieving means 436, a second interpreter 438, and a second sending means 440. The user interface 404 records the operations of users 414, wherein the user interface 404 may be a plurality of bottoms for generating the operations of users 414 whenever each of the bottoms is pressed, the first interpreter 406 translates the operations of users 414 into a first signal 420, and the first sending means 408 sends the first signal 420 by a first wireless protocol.

Then the second receiving means 434 receives the first signal 420, and the second interpreter 438 translates a multimedia data 442 into a second signal 444 after the retrieving means 436 retrieves the multimedia data 442 over a network according to the first signal 420, wherein the multimedia data 442 is received from a remote computer 470. The playing means 412 plays the multimedia data 442 after the first receiving means 410 receives the second signal 444 sent by the second sending means 440 by a second wireless protocol, wherein the playing means 412 further comprises a display 423 and a speaker 424 for playing the multimedia data 442. Besides, the operations of users 414 further include audio, video, e-mail and so on.

According to the third embodiment of the present invention, the first signal 420 may be analog as being sent by infrared ray and the second signal 444 may be digital as being sent by radio. Nevertheless, the first signal 420 and the second signal 444 may also be sent by the same protocol whether the protocol is analog or digital. In addition, the multimedia data 442 is retrieved over the VoIP protocol or the VoIM protocol, wherein the retrieving means 436 performs an instant messenger program for retrieving the multimedia data 442 over the VoIM protocol from another instant messenger program performed on the remote computer 470. Furthermore, the controlled computer 432 may perform a program 480 according to the first signal 420 over the VoIP protocol or the VoIM protocol.

As shown in FIG. 4b, the remote control 402 further comprises a repeater 428. The repeater 428 sends the multimedia data 442 to a playing device 490 for playing the multimedia data 442 received from the remote control 402 by a third wireless protocol.

As shown in FIG. 4c, the user interface 404 may record the audio of the users 494 or the video of the users 496, and the first sending means 408 sends the first signal 420 by the first wireless protocol, wherein the first signal 420 is translated from the audio of the users 494 or the video of the users 496 by the first interpreter 406. Then the controlled computer 432 may play the audio of the users 494 or the video of the users 496, or the second sending means 440 resends the audio of the users 494 or the video of the users 496 to the playing device 490 after the second receiving means 434 receives the first signal 420 by the first wireless protocol.

As shown in FIG. 4d, the remote control 402 sends the first signal 420 according to the operations of the users 414, wherein the first signal 420 is sent via the infrared ray, and according to the first signal 420, the controlled computer 432 sends the second signal 444 translated from the multimedia data 442 back to the remote control 402 after retrieving the multimedia data 442 from the remote computer 470 over the network, wherein the second signal 444 is sent via the radio. Then the remote control 402 plays the multimedia data 442, or resends the multimedia data 442 to the playing device 490 as a DVD player, a TV, a computer, etc. According to the first signal 420, the controlled computer 432 may perform a program 480 over the VoIP protocol or the VoIM protocol, wherein the program 480 may be to play songs, to calculate math problems, to search any data from the database of the controlled computer 432, and so on.

In addition, the remote control 402 further comprises a recording means 493 for recording the audio of the users 494 or the video of the users 496, and sends the audio of the users 494 or the video of the users 496 to the controlled computer 432 via the infrared ray, and then the controlled computer 432 may play the audio of the users 494 or the video of the users 496, or resend the audio of the users 494 or the video of the users 496 to the remote computer 470 over the VoIP protocol or the VoIM protocol, or to the playing device 490 via the radio.

Furthermore, the remote control 402 may sends an e-mail of the users 498 to the controlled computer 432 via the infrared ray, and then the controlled computer 432 resends the e-mail of the users to the remote computer 470 over the network.

Moreover, the multimedia data 442 may be encoded, encrypted, or compressed by the controlled computer 432 and decoded, decrypted, or decompressed by the remote control 402 for playing or resending the multimedia data 442 to the playing device 490 after the remote control 402 receives the multimedia data 442, or the remote control 402 may immediately play or resend the multimedia data 442 to the playing device 490 after the remote control 402 receives the multimedia data 442 decoded, decrypted, or decompressed by the controlled computer 432, wherein the playing device 490 can be combined with the control client 400. Beside the above-mentioned description, the first signal 420 may be sent by an analog or a digital way as infrared ray, radio, WiFi, BlueTooth, ZigBee, or Internet, and so does the second signal 444.

The same as above, the audio of the users 494 or the video of the users 496 may be encoded, encrypted, or compressed by the remote control 402 and decoded, decrypted, or decompressed by the controlled computer 432 for playing or resending the audio of the users 494 or the video of the users 496 to the remote computer 470 after the controlled computer 432 receives the audio of the users 494 or the video of the users 496.

In one preferred example according to the present invention, the remote control 402 may be the combination of a common remote control and a hand-held TV. The common remote control can convert the operations of the users 414 into the first signal for demanding a multimedia data and send the first signal to the controlled computer via infrared ray, then the remote controlled computer retrieve the multimedia data demanded by the users. Afterwards, the controlled computer sends the multimedia data to the remote control by radio. Therefore the hand-held TV of remote control can plays the multimedia data 442 received from the TV via wireless channel.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled.

It is understood that several modifications, changes, and substitutions are intended in the foregoing disclosure and in some instances some features of the invention will be employed without a corresponding use of other features. Accordingly, it is appropriate that the appended claims be construed broadly and in a manner consistent with the scope of the invention.

1. A client/server multimedia system, comprising:
a control client for sending a first signal according to a first wireless protocol and playing a multimedia data received according to a second wireless protocol, wherein said control client comprising:
a user interface for recording the operations of users;
a first interpreter for translating said operations of users into said first signal;
a first sending means for sending said first signal according to said first wireless protocol;
a first receiving means for receiving a second signal according to said second wireless protocol;
a playing means for playing said multimedia data;
a multimedia server for receiving said first signal according to said first wireless protocol and sending said second signal according to said second wireless protocol, wherein said multimedia server comprising:
a second receiving means for receiving said first signal according to said first wireless protocol;
a retrieving means for retrieving said multimedia data over said network according to said first signal, wherein said multimedia data is received from a remote computer;
a second interpreter for translating said multimedia data into said second signal; and
a second sending means for sending said second signal according to said second wireless protocol.

2. A client/server multimedia system of claim 1, wherein said first signal is sent by infrared ray and said second signal is sent by radio.

3. A client/server multimedia system of claim 1, wherein said first signal is analog and said second signal is digital.

4. A client/server multimedia system of claim 1, wherein said first protocol and said second protocol are the same.

5. A client/server multimedia system of claim 1, wherein said user interface is a keyboard with a plurality of bottoms, wherein said operations of users is generating whenever each of said bottoms is pressed.

6. A client/server multimedia system of claim 1, wherein said playing means comprises a display and a speaker for playing said multimedia data.

7. A client/server multimedia system of claim 1, wherein said multimedia data is retrieved over the VoIP (Voice over Internet Protocol) protocol over said network.

8. A client/server multimedia system of claim 1, wherein said multimedia data is retrieved over the VoIM (Voice over Instant Messenger) protocol, wherein said retrieving means performing a instant messenger program for retrieving said multimedia data over said VoIM protocol from another instant messenger program performed on said remote computer.

9. A client/server multimedia system of claim 1, wherein said multimedia server performs a program according to said first signal over said VoIM protocol or said VoIP protocol.

10. A client/server multimedia system of claim 1, wherein said control client further comprises a repeater for sending said multimedia data by a third wireless protocol.

11. A client/server multimedia system of claim 9, further comprising a playing device for playing said multimedia data received from said control client by said third wireless protocol.

12. A client/server multimedia system of claim 11, wherein said playing device is combined with said control client.

13. A client/server multimedia system of claim 1, wherein said control client further comprises a recording means for recording said multimedia data and sending said multimedia data to said first interpreter, wherein said multimedia data is the audio of the users or the video of the users.

14. A client/server multimedia system of claim 13, wherein said multimedia data is encrypted/decrypted by said control client or said multimedia server.

15. A client/server multimedia system of claim 13, wherein said multimedia data is compressed/decompressed by said control client or said multimedia server.

16. A client/server multimedia system of claim 1, wherein said first signal and said second signal are sent by an analog or a digital way as infrared ray, radio, WiFi, BlueTooth, ZigBee, or Internet.

17. A method for providing a client/server multimedia system with a multimedia server and a control client, comprising:
recording the operations of users by said control client;
translating said operations of users into a first signal by said control client;
sending said first signal to a multimedia server directly via a first wireless protocol by said control client;
receiving said first signal by said multimedia server;
retrieving a multimedia data over a network according to said first signal by said multimedia server, wherein said multimedia data is received from a remote computer;
translating said multimedia data into said second signal by said multimedia server;
sending said second signal via a second wireless protocol by said multimedia server;
receiving said second signal by said control client; and
playing said multimedia data by said control client.

18. A method for providing a client/server multimedia system of claim 17, wherein said first signal is analog and said second signal is digital.

19. A method for providing a client/server multimedia system of claim 17, wherein said first signal is sent by infrared ray and said second signal is sent by radio.

20. A method for providing a client/server multimedia system of claim 17, wherein said first protocol and said second protocol are the same.

21. A method for providing a client/server multimedia system of claim 17, wherein said multimedia data is retrieved over the VoIP protocol over said network.

22. A method for providing a client/server multimedia system of claim 17, wherein said multimedia data is retrieved over the VoIM protocol, wherein said multimedia server performs a instant messenger program for retrieving said multimedia data over said VoIM protocol from another instant messenger program performed on said remote computer.

23. A method for providing a client/server multimedia system of claim 17, wherein said multimedia server performs a program according to said first signal over said VoIM protocol or said VoIP protocol.

24. A method for providing a client/server multimedia system of claim 17, further comprising a sending step, wherein said sending step is for sending said multimedia data according to a third wireless protocol by said control client.

25. A method for providing a client/server multimedia system of claim 24, further comprising a playing step, wherein said playing step is for playing said multimedia data by a playing device, wherein said multimedia data is received from said control client according to said third protocol.

26. A method for providing a client/server multimedia system of claim 28, wherein said playing device is combined with said control client.

27. A method for providing a client/server multimedia system of claim 17, further comprising a recording step, wherein said recording step is for recording said multimedia data for translating said multimedia data into said first signal by said control client, wherein said multimedia data is the audio of the users or the video of the users.

28. A method for providing a client/server multimedia system of claim 27, further comprising an encrypting/decrypting step, wherein said encrypting/decrypting step is for encrypting/decrypting said multimedia data by said control client or said multimedia server.

29. A method for providing a client/server multimedia system of claim 27, further comprising a compressing/decompressing step, wherein said compressing/decompressing step is for compressing/decompressing said multimedia data by said multimedia.

30. A method for providing a client/server multimedia system of claim 17, wherein said first signal and said second signal are sent by an analog or a digital way as infrared ray, radio, WiFi, BlueTooth, ZigBee, or Internet.
